(19) United States
(12) Patent Application Publication
(10) Pub. No.: US 2001/0022803 A1
(43) Pub. Date: Sep. 20, 2001

(54) Temperature-detecting element

(76) Inventors: Yoshihiro Suzuki, Tokyo (JP); Hitoshi Nakane, Tokyo (JP); Satoshi Oka, Tokyo (JP); Kousuke Yaguchi, Tokyo (JP)

Correspondence Address: Joseph S. Iandiorio, 260 Bear Hill Road, Waltham, MA, 02154, US

(21) Appl. No.: 09/769,919

(22) Filed: Jan. 25, 2001

(30) Foreign Application Priority Data
Jan. 28, 2000 (JP) 020977/2000

(51) Int. Cl. G01K 1/14; G01K 7/04; G01K 1/16; G01K 13/00

(52) U.S. Cl. 374/141; 374/179; 374/134; 374/208

(57) ABSTRACT

A temperature-detecting element 5 detects the temperature of a workpiece in a furnace. The element 5 comprises a temperature-sensing portion 1 which is disposed in a furnace at a location adjacent to position where workpiece is to be held, and a splinter 3 made of similar material to the workpiece and held in contact with the temperature-sensing portion 1. When the workpiece temperature is raised quickly, the splinter 3 produces such surroundings of the temperature-sensing portion 1 that the portion 1 is caused to have similar radiation-receiving ability to that of the workpiece. The material of the splinter 3 may have similar thermal properties as that of the workpiece.

### TECHNICAL FIELD

This invention relates to a temperature-detecting element, and more specifically to such a temperature-detecting element for monitoring furnace inside temperature which element has a temperature-sensing portion that is held in contact with a splinter of workpiece being treated in the furnace.

### BACKGROUND ART

Heat treatment of silicon or other semiconductor wafer (to be referred to as “wafer”, hereinafter) has been used for various purposes, such as wafer surface treatment for doping, anneal, chemical vapor deposition (CVD), and the like. The quality of heat treatment depends on the temperature at which it is effected. Hence, the accuracy of temperature measurement during the heat treatment greatly affects the quality of finished goods, for instance the quality of membrane that is formed on the surface of wafer (to be referred to as “formed membrane”, hereinafter). An ideal method of measuring temperature with sufficient accuracy for ensuring high quality of formed membrane is to measure directly the wafer temperature by bringing a sensor into solid contact with the wafer. In most practical cases, however, various requirements for facilitating mechanical operations of the heat treatment process hamper such direct temperature measurement. As a result, temperature-detecting elements have been placed in the proximity of the wafer or similar workpiece with a distance of as small as possible from the workpiece.

Referring to FIG. 3, for instance, a number of wafers 10 are loaded on a quartz boat 11 which is in turn placed within a tube-like quartz housing 12 for heat treatment. One or more slender blind quartz tubes 2 (only one is shown in FIG. 3) are fixed to the inside surface of the quartz housing 12. Each blind quartz tube 2 has a closed end and carries a temperature-sensing portion 1 placed in the closed end. The temperature-sensing portions 1 are disposed as close to the wafers 10 as possible, so as to measure their temperatures as a kind of approximate values. Thermocouples are commonly used to form temperature-detecting elements 5 to measure the temperature of wafers 10. The temperature-sensing portion 1 of each temperature-detecting element 5 is formed of the temperature-sensing contact of a thermocouple, which contact is made by bonding end portions of two different thermocouple conductors 7 for instance by fusing. In FIG. 3, the temperature-sensing element 5 consists of a slender quartz tube 2 and a thermocouple placed therein.

In case of treating wafers 10 in the tube-like quartz housing 12 of FIG. 3, when the speed of increasing temperature is low, the wafers 10 are heated mostly by thermal conduction. However, when the speed of increasing temperature is high, the wafers 10 are heated mostly by thermal radiation. The inventors carried out experiments on the response of the temperature-sensing portion 1 of FIG. 3 to quick temperature rise. It was found that there was a difference between the temperature on the surface of the wafer 10 (to be referred to as “the wafer surface temperature”, hereinafter) and the measured value of the temperature-detecting element 5 measuring the furnace inside temperature. In general, there is a transient period in which the wafer surface temperature is higher than that of the temperature-sensing portion 1 of the temperature-detecting element 5.

FIG. 5 shows an example of the result of the above experiments of the inventors. In the experiments, wafers 10 were loaded in the tube-like quartz housing 12 as shown in FIG. 3 for producing a film on the surface of each wafer 10. Separate test temperature sensors (not shown) were directly mounted at a central and a peripheral portion on the surface of one of such wafers 10, respectively. Peripheral portion temperature M1 and central portion temperature M2 of the wafer 10 were measured by the test temperature sensors. The temperature-sensing portion 1 in the temperature-detecting element 5 of FIG. 3 was the temperature-sensing contact of a thermocouple, and the output of that thermocouple is shown by the curve MTC-C in FIG. 5. In the above experiments, the diameter of the wafer 10 was about 150 mm, the diameter of the slender quartz tube 2 was about 7 mm, and the diameter of the temperature-sensing portion 1 was about 1 mm.

The thermocouple output temperature MTC-C was applied to a temperature controller (not shown) for heat treating the wafers 10 in the tube-like quartz housing 12. The curves M1, M2 and MTC-C of FIG. 5 show the variation of the respective temperatures during the heat treatment of the wafers 10. The experimental results shown in FIG. 5 involve an overshoot of wafer surface temperatures M1, M2 over preset values by about 70° C. Maximum instantaneous difference between the wafer central portion temperature M2 and the thermocouple output temperature MTC-C was found to be about the same as the magnitude of the overshoot. The above temperature overshoot has significant influence both on the quality of membrane adherence to silicon substrate and on the unevenness of membrane thickness within expanse of the wafer surface.

### DISCLOSURE OF INVENTION

Therefore, an object of the present invention is to provide a temperature-detecting element for measuring furnace inside temperature, which element can closely follow any quick temperature change of wafer or other workpiece being heated in the furnace.

The inventors noted the above-mentioned fact that, when speed of raising temperature is high, workpiece is heated mainly by thermal radiation. Planar workpiece, such as a wafer 10, has a comparatively large surface area for receiving incident thermal radiation or radiation-receiving area. On the other hand, conventional temperature-detecting element 5 as shown in FIG. 4, uses a temperature-sensing portion 1 with a very small radiation-receiving area or a point-like minuscule area as compared with the wafer 10. This difference in the radiation-receiving area between the wafer 10 and the temperature-sensing portion 1 appears to cause time delay of the output of the temperature-detecting element 5 as compared to the actual temperature change on the wafer 10.

The inventors have reached to a concept that if the heat-radiation-receiving area of temperature-sensing portion 1 is made large, the above-mentioned delay in the output from the temperature-detecting element 5 will be suppressed. The invention has been completed on the basis of this concept.

### BRIEF DESCRIPTION OF DRAWINGS

For a better understanding of the invention, reference is made to the accompanying drawings, in which

FIG. 1 is a sectional view of the essential portion of an embodiment of the temperature-detecting element of the invention;

FIG. 2 is a sectional view of the essential portion of another embodiment of the invention;

FIG. 3 is a diagrammatic illustration of a tube-like quartz housing for heat treatment of silicon wafers;

FIG. 4 is a sectional view of the essential portion of a temperature-detecting element of prior art;

FIG. 5 is a graph showing the result of furnace temperature control by using a temperature-detecting element of prior art; and

FIG. 6 is a graph showing the result of furnace temperature control by using a temperature-detecting element according to the invention.

### BEST MODE FOR CARRYING OUT THE INVENTION

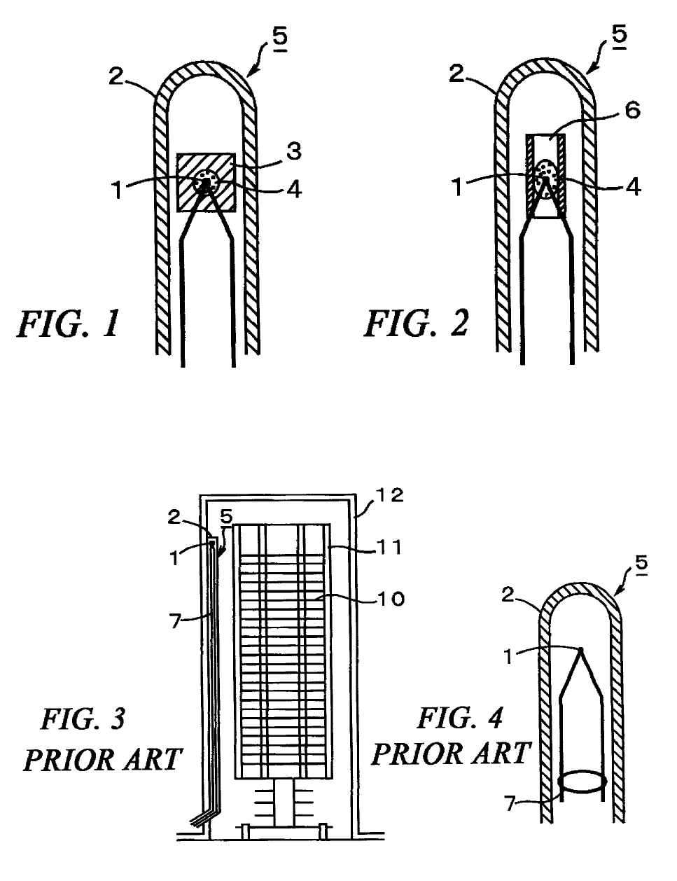

Referring to FIG. 1, a temperature-detecting element 5 according to the invention is for detecting the temperature of a workpiece such as a wafer 10 in a furnace. The element 5 comprises a temperature-sensing portion 1 which is disposed in a furnace at a location adjacent to position where the workpiece (e.g., wafer 10) is to be held, and a splinter 3 of certain material held in contact with the temperature-sensing portion 1. The material of the splinter 3 has similar thermal properties as that of the workpiece.

Preferably, the splinter 3 is a small piece taken from the workpiece or wafer 10 to be thermally treated in the furnace. The splinter 3 may be bonded to the temperature-sensing portion 1 by an adhesive 4 of inorganic compound system or by using molten glass.

The function of the temperature-detecting element 5 of FIG. 1 will now be described. The splinter 3 of workpiece (e.g., wafer 10) held in contact with the temperature-sensing portion 1 of the element 5 produces such thermal conditions in the surrounding of the portion 1 that is similar to that in which the workpiece receives thermal radiation from a heater (not shown). As a result, the temperature-detecting element 5, which is not indirect contact with the workpiece, is enabled to measure the variation of temperature of the workpiece as if the temperature-sensing portion 1 of the element 5 were in direct contact with the workpiece.

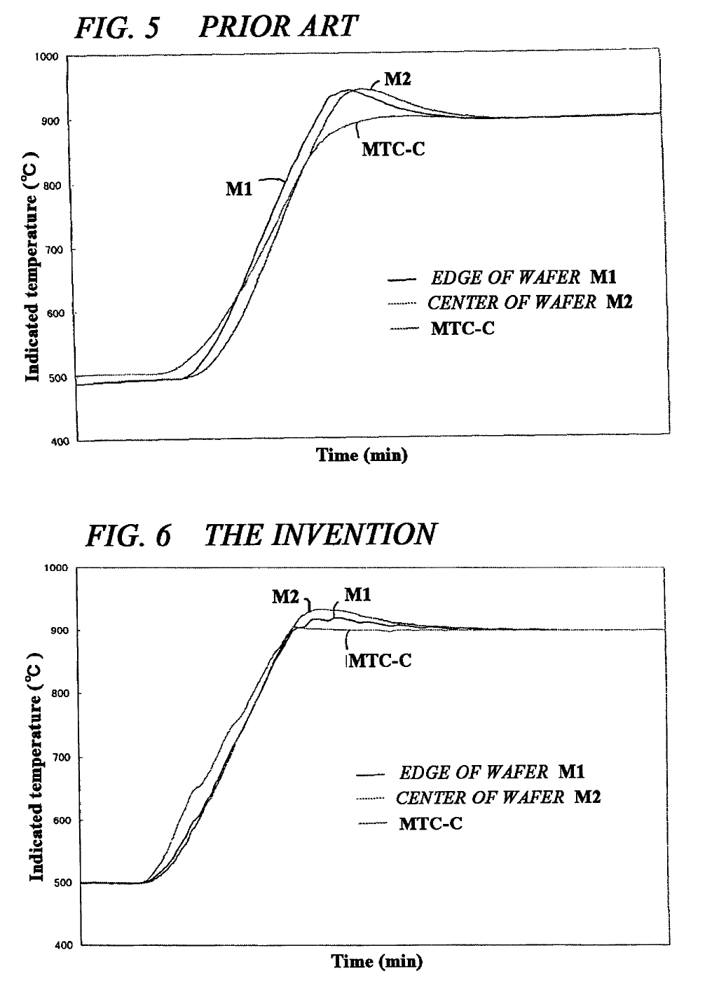

Confirmation tests were made by carrying out the same control of heat treatment as that of FIG. 5 by using a temperature-detecting element 5 of the invention as shown in FIG. 1, instead of the conventional element 5 of FIG. 4. The result is shown in FIG. 6. The splinter 3 in the temperature-detecting element 5 used in the confirmation tests was taken from the wafer 10 and was in the form of a thin disk with a diameter of about 5 mm. Instantaneous values of both the overshoot of wafer surface temperature over the preset target value and the deviation of the thermocouple output temperature MTC-C from the wafer center temperature M2 were reduced to about 30° C., respectively. Thus, the invention has succeeded in reducing both of the above overshoot and the deviation by about 40° C., as can be seen from the comparison of FIGS. 5 and 6.

As compared with the curves of FIG. 5 obtained by the prior art, the curves of FIG. 6 obtained by the invention have a shorter recovery time from the overshoot temperature of the workpiece. The cause of such shorter recovery time is in the above-mentioned smaller deviation of the thermocouple output temperature MTC-C from the wafer center temperature M2.

Thus, the object of the invention, i.e., to provide a temperature-detecting element for measuring furnace inside temperature, which element can closely follow any quick temperature change of wafer or other workpiece in the furnace, has been fulfilled.

FIG. 2 shows another embodiment of the invention. In this case, to facilitate insertion into the slender quartz tube 2 and to provide for stronger bondage with the temperature-sensing potion 1 by the adhesive 4, a small ceramic cylinder 6 is used instead of the planar splinter 3 of silicon wafer of FIG. 1.

The inventors confirmed the embodiment of FIG. 2 has the same effects as that of FIG. 1 by making actual models and testing them. More specifically, a temperature-sensing contact of thermocouple (i.e., a temperature-sensing portion 1) was joined to a small ceramic cylinder 6, and the small ceramic cylinder 6 carrying the temperature-sensing portion 1 was inserted into a slender quartz tube 2 to form a temperature-detecting element 5. The temperature-detecting element 5 thus prepared proved to have the same improved performance as that of FIG. 1.

The fundamental concept of the temperature-detecting element 5 of the invention is in that an enhancing means for improving radiation-receiving ability of a minuscule temperature-sensing portion 1 of element 5 is added to that portion 1. The above-mentioned enhancing means can be in the form of a splinter 3 taken from workpiece or wafer 10. The splinter 3 is large enough to give such radiation-receiving ability to the temperature-sensing portion 1 that the portion 1 can be heated at about the same speed as that of the workpiece or the wafer 10. At the same time, the splinter 3 is small enough to avoid interference with mechanical operations necessary for the heat treatment.

### INDUSTRIAL APPLICABILITY

As described in detail in the foregoing, the temperature-detecting element of the present invention is to measure the temperature of workpiece in furnace and uses a splinter of such material in contact with the temperature-sensing portion that has similar thermal properties as that of the workpiece. Hence, the temperature-detecting element of the invention suits the following applications.

(a) To suppress overshoot of the temperature of a workpiece in excess of target value in controlling the temperature of the workpiece, and to improve the quality of the workpiece thus heat treated.

(b) To improve the ability of a temperature-detecting element to follow change in temperature of a workpiece, as compared with similar elements of prior art.

(c) Consequently, to shorten the time necessary for heat treatment process and to improve throughput of the process.

(d) To gain better uniformity in the thickness of film formed on wafer, by suppressing overshoot of wafer temperature in its heat treatment.

(e) To provide such an indirect temperature-measuring system that produces, without direct contact of sensor with workpiece, substantially the same measured value as that obtained by bringing sensor into direct contact with workpiece being heat treated.

Although the invention has been described in the foregoing by referring to specific examples, it should be understood that numerous changes in details of construction and combination and arrangement of parts may be resorted to without departing from the spirit and scope of the invention as hereinafter claimed.

1. A temperature-detecting element for detecting the temperature of a workpiece in a furnace, said element comprising a temperature-sensing portion which is disposed in a furnace at a location adjacent to position where workpiece is held, and a splinter of such material held in contact with the temperature-sensing portion, which material has similar thermal properties as that of the workpiece.

2. A temperature-detecting element as set forth in claim 1, wherein said workpiece is made of semiconductor and said splinter is a small piece taken from said workpiece.

3. A temperature-detecting element as set forth in claim 1, wherein said element further comprises a slender quartz tube disposed in a furnace at a location adjacent to position where workpiece is to be held, and said temperature-sensing portion and said splinter are both placed in the quartz tube, said splinter is bonded to the temperature-sensing portion by an adhesive.

4. A temperature-detecting element as set forth in claim 2, wherein said element further comprises a slender quartz tube disposed in a furnace at a location adjacent to position where workpiece is to be held, and said temperature-sensing portion and said splinter are both placed in the quartz tube, said splinter is bonded to the temperature-sensing portion by an adhesive.

5. A temperature-detecting element as set forth in claim 3, wherein said splinter is a small ceramic cylinder and said temperature-sensing portion is bonded to the inside of the small ceramic cylinder.

6. A temperature-detecting element as set forth in claim 4, wherein said splinter is a small ceramic cylinder and said temperature-sensing portion is bonded to the inside of the small ceramic cylinder.
